(19) United States
(12) Patent Application Publication
(10) Pub. No.: US 2020/0084435 A1
(43) Pub. Date: Mar. 12, 2020

(54) METHOD AND SYSTEM FOR DISPLAYING AESTHETIC IMAGE STREAMS

(71) Applicant: Unser Pty Ltd, Perth (AU)

(72) Inventor: Marc HARRIES, Coolbinia (AU)

(21) Appl. No.: 16/467,298

(22) PCT Filed: Dec. 7, 2017
(86) PCT No.: PCT/AU2017/051347

§ 371 Date: Jun. 6, 2019

(30) Foreign Application Priority Data
Dec. 7, 2016 (AU) 2016905049

(51) Int. Cl. H04N 13/398; H04N 21/81; H04N 21/84; G06F 16/438

(52) U.S. Cl. CPC H04N 13/398; H04N 21/812; H04N 2201/0089; G06F 16/4393; H04N 21/84

(57) ABSTRACT

A method, comprising: receiving an image stream at a display screen, wherein the image stream comprises a plurality of images each having aesthetic value; displaying each image on the display screen in silence without accompanying sound; displaying each image on the display screen for a display period greater than 1 second and less than 1 minute.

### FIELD

The present invention relates to a method and related system for displaying aesthetic image streams.

### BACKGROUND

Conventional digital advertising is intended to attract consumers' attention to a barrage of rapidly changing digitised images and sounds generated by digital signs and billboards. The proliferation of conventional digital signs and billboards in public spaces creates aesthetic pollution or contamination that disturbs and offends the eyes and ears of viewers. When too many images and sounds are presented—especially haphazardly—the result is visual and auditory clutter that is confusing and overwhelming. The aesthetic pollution and clutter created by conventional digital advertising corrupts and destroys aesthetic value and experience, and creates cognitive dissonance that adversely impacts the psychological state and wellbeing of the audience.

In this context, there is a need for improved solutions for digital advertising.

### SUMMARY

According to the present invention, there is provided a method, comprising:
receiving an image stream at a display screen, wherein the image stream comprises a plurality of images each having aesthetic value;
displaying each image on the display screen in silence without accompanying sound;
displaying each image on the display screen for a display period greater than 1 second and less than 1 minute.

Each image in the image stream may be aesthetically pleasing and of high aesthetic value or quality to viewers of the display.

The display period may be between 5 seconds and 30 seconds, for example, around 15 seconds.

The method may further comprise displaying an advertising feed on the display screen adjacent to the image stream.

The method may further comprise displaying a news feed on the display screen adjacent to the image stream.

The method may further comprise displaying a business news feed on the display screen adjacent to the image stream.

The method may further comprise displaying a weather feed on the display screen adjacent to the image stream.

The method may further comprise displaying a trivia feed on the display screen adjacent to the image stream.

The method may further comprise displaying time and date on the display screen adjacent to the image stream.

The method may further comprise displaying a welcome message on the display screen adjacent to the image stream.

The display screen may comprise a display screen of a digital device selected from a digital sign, a digital display, a personal computer, a laptop computer, a tablet computer, a smartphone, a smartwatch, a smart television, and combinations thereof.

The method may further comprise capturing viewer responses while viewing the image stream on the display screen.

The method may further comprise analysing the viewer responses.

The present invention also provides a display screen generated on a digital device by the method described above.

The present invention further provides a system, comprising:

a processor; and

a non-transitory computer-readable medium coupled to the processor and having instructions stored thereon, which, when executed by the processor, cause the processor to perform operations comprising:
receiving an image stream at a display screen, wherein the image stream comprises a plurality of images each having aesthetic value;
displaying each image on the display screen in silence without accompanying sound;
displaying each image on the display screen for a display period greater than 1 second and less than 1 minute.

The present invention also provides a non-transitory computer-readable medium having instructions stored thereon, which, when executed by a processor, cause the processor to perform operations comprising:

receiving an image stream at a display screen, wherein the image stream comprises a plurality of images each having aesthetic value;

displaying each image on the display screen in silence without accompanying sound;

displaying each image on the display screen for a display period greater than 1 second and less than 1 minute.

The present invention further provides a system comprising a plurality of networked digital signs each configured to perform the method described above.

The present invention also provides a virtual art gallery comprising a plurality of networked display devices simultaneously displaying display screens generated by the method described above.

### BRIEF DESCRIPTION OF DRAWINGS

Embodiments of the invention will now be described by way of example only with reference to the accompanying drawings, in which:

FIG. 1 is a flowchart of a computer-implemented method for displaying aesthetic images according to an embodiment of the present invention;

FIGS. 2 to 5 are example display screens generated on a display device by the method;

FIGS. 6 and 7 are example system architectures for implementing the method; and

FIGS. 8 and 9 are further example display screens generated on a display device by the method.

### DESCRIPTION OF EMBODIMENTS

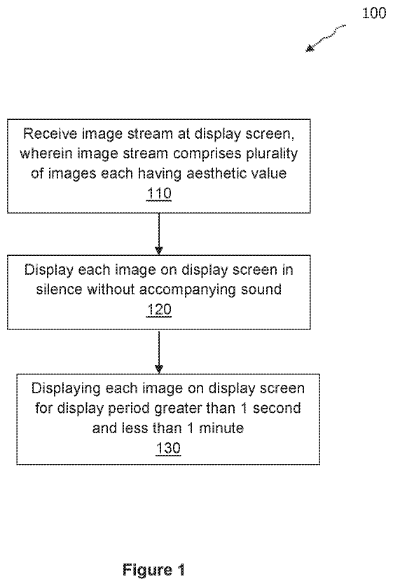

Referring to FIG. 1, a computer-implemented method 100 for displaying aesthetic images according to an embodiment of the present invention starts by receiving an image stream at a display screen (110). The display screen may comprise a display screen of a digital device selected from a digital sign, a digital display, a personal computer, a laptop computer, a tablet computer, a smartphone, a smartwatch, a smart television, and combinations thereof. The image stream may comprise a plurality of images each having aesthetic value. Each image in the image stream may be aesthetically pleasing and of high aesthetic value or quality to viewers of the display. The image stream may further comprise video streams, image video streams, video image streams, and combinations thereof.

Next, each image in the image stream may be displayed on the display screen in silence without accompanying sound (120). The method 100 ends by displaying each image in the image stream on the display screen for a display period greater than 1 second and less than 1 minute (130). The display period may be between 5 seconds and 30 seconds, for example, around 15 seconds.

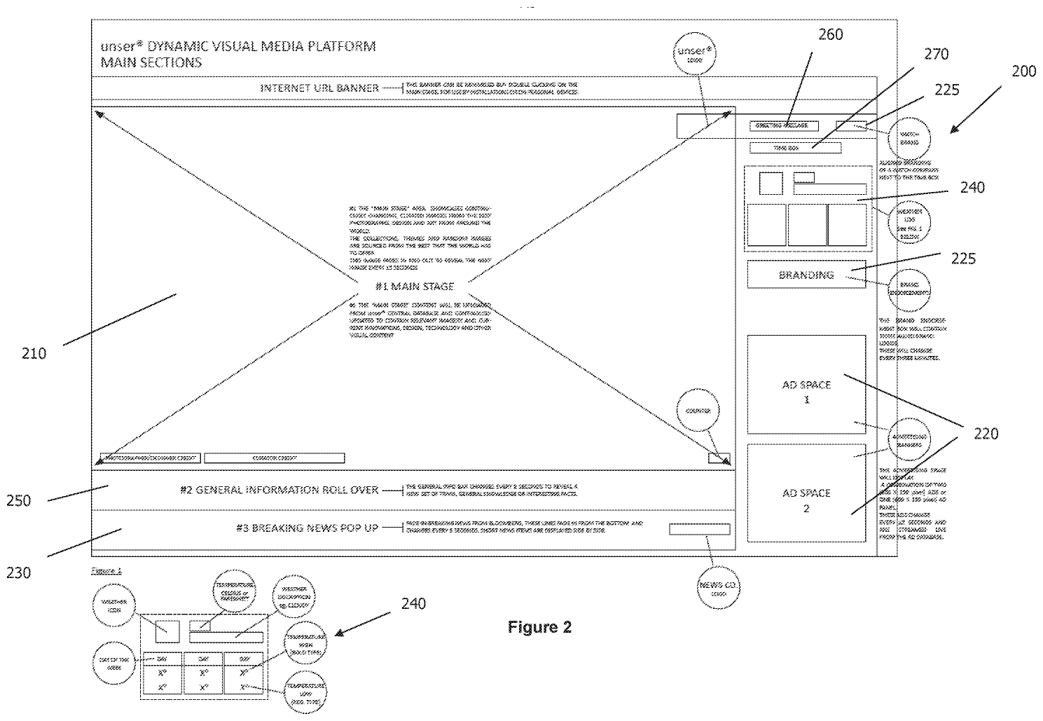

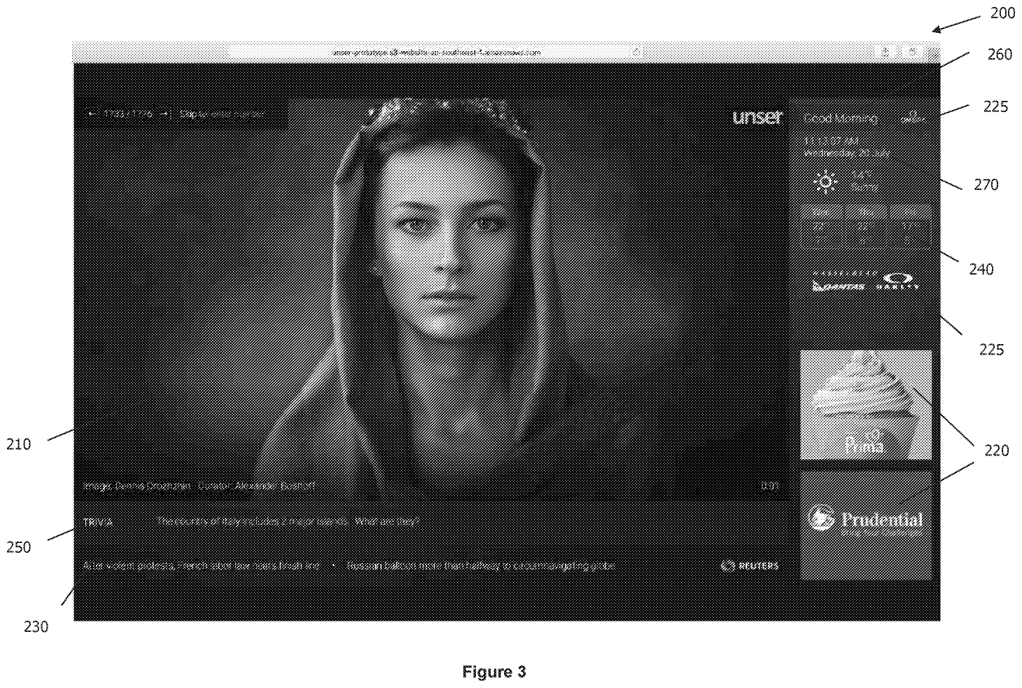

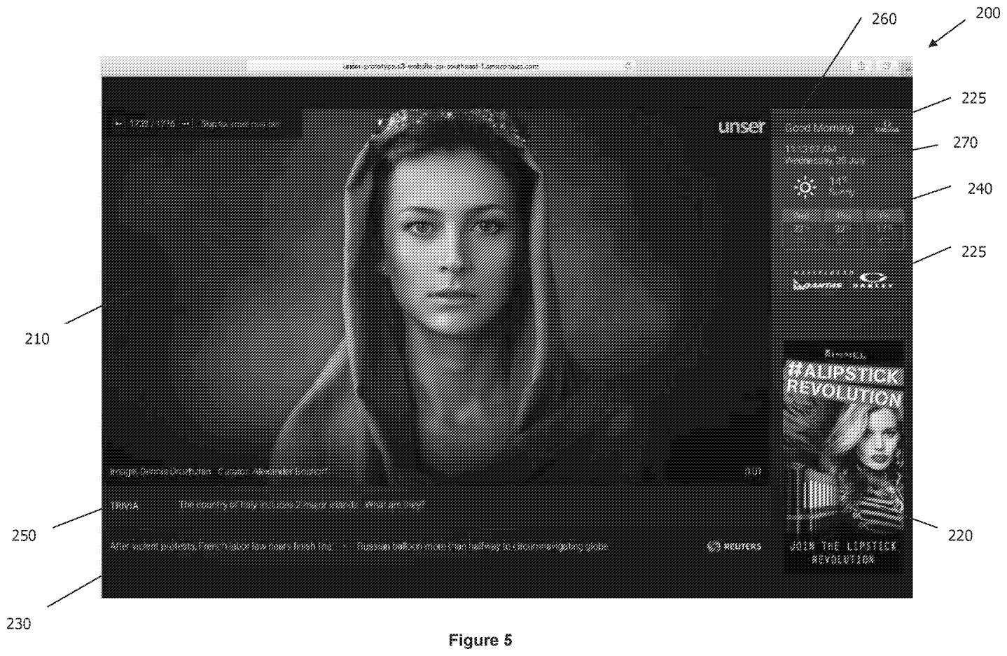

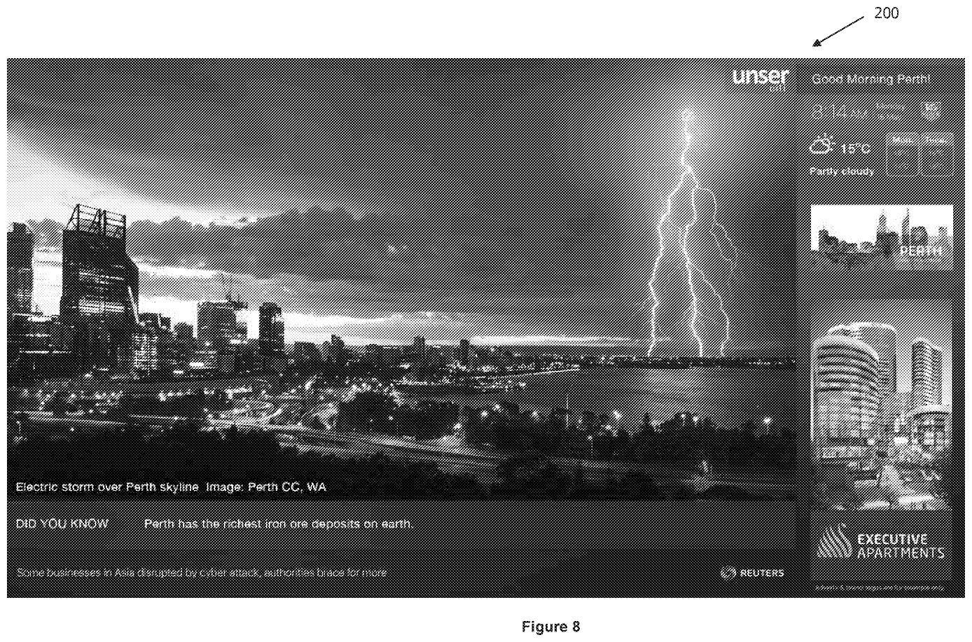

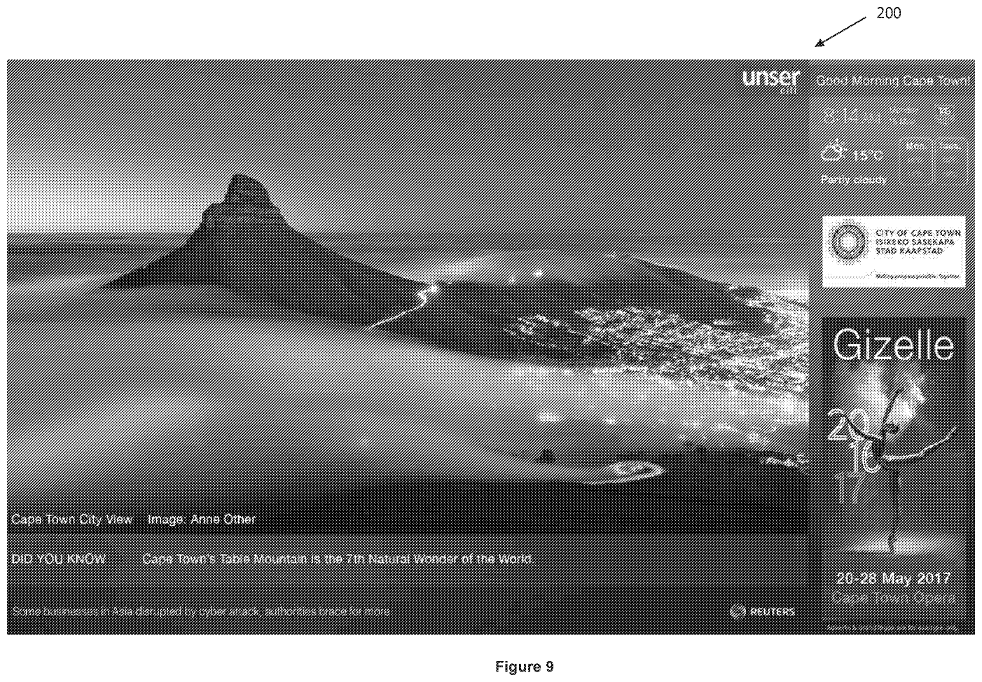

FIGS. 2 to 5 are example display screens 200 generated on a display device by the computer-implemented method 100. The image stream may be displayed on a major portion (or “main stage”) 210 of the display screen 200. While it is not intended to be bound to any particular theory, it is believed that the cumulative effect of displaying the aesthetically pleasing images in silence for around 15 seconds may create a sequence of positive aesthetic experiences that may have a positive impact on the psychological state or wellbeing of the viewers. Furthermore, the method 100 may induce, elicit or evoke neuroplasticity (or positive neurophysiological responses) in the viewers that enhance cognitive functions including learning and memory formation. FIGS. 8 and 9 are further example display screens 200 generated by the method 100 which are both generally and specifically useful for customising to advertise or promote geographic regions, states, provinces, towns, cities, etc. For example, residents or local people in each city or state may manage and market their locations using these “City/State” display screens 200 and receive in return a share of advertising income. Such “City/State” display screens 200 enable residents to promote their City/State through the eyes of its people.

The method 100 may further comprise displaying one or more advertising feeds 220 on the display screen 200 adjacent to the image stream 210. The positive aesthetic experience created by the stream of aesthetically pleasing images 210 may act as a “psychological hook” that engages the viewers, and may also act as a “nudge” in the sense of behavioural economics that makes viewers choose to view and engage with the advertising feeds 220.

The method 100 may further comprise displaying various other types of digital content on the display screen 200 adjacent to the stream of aesthetically pleasing images 210. For example, a news feed 230 may be displayed on the display screen 200 adjacent to the image stream 210. Optionally, a financial or business news feed (not shown) may further be displayed on the display screen 200 adjacent to the image stream 210.

A weather feed 240 and a trivia feed 250 may also be displayed on the display screen 200 adjacent to the image stream 210. A welcome message 260 and the time and date 270 may further be displayed on the display screen 200 adjacent to the image stream 210.

The method 100 may further comprise capturing viewer responses of viewers while viewing the image stream 210 on the display screen 200. The viewer responses may, for example, be captured by a camera positioned on the display device adjacent to the display screen 200. The viewer responses may, for example, be analysed by eye tracking software to provide viewer analytics to advertisers. Further or alternatively, the viewer responses may be provide viewer analytics to produce data for behavioural sciences.

A plurality of digital screens may be networked together to perform the method 100 with the same or different image streams and digital content. For example, a plurality of networked digital signs may each be configured to perform the method 100 with location-specific image streams and content feeds. Furthermore, an ad hoc virtual art gallery or display may be generated by performing the method 100 simultaneously on a plurality of networked display devices, such as personal computers in an office space, with different image streams.

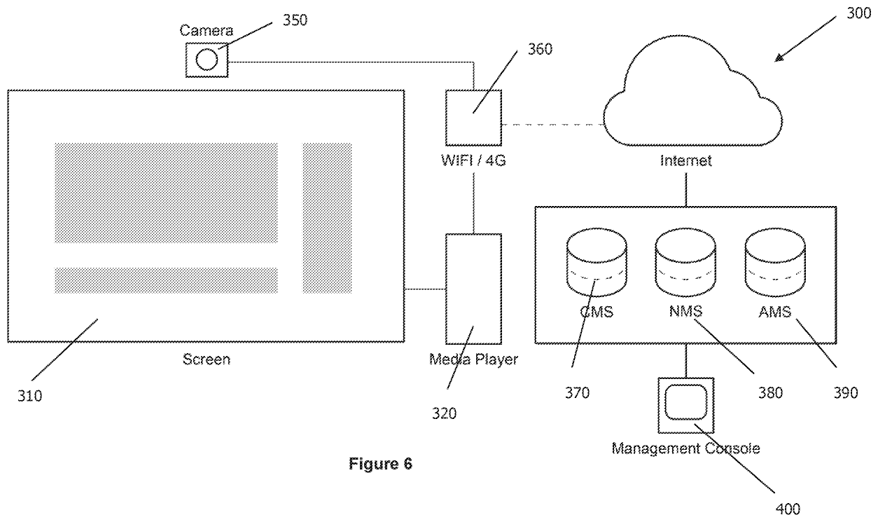

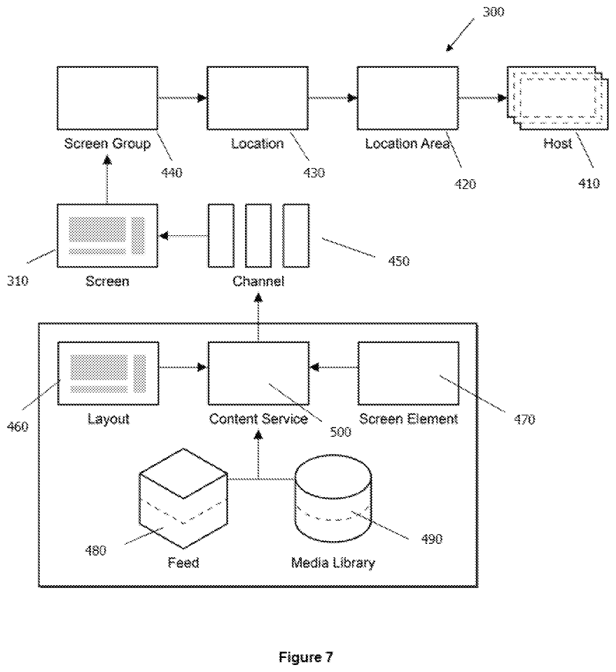

FIGS. 6 and 7 illustrate example system architectures for implementing the method 100. Referring to FIG. 6, a system for displaying aesthetic images 300 may comprise one or more display screens 310 that display digital signage content described above to an audience. The display screens 310 may be mounted in public places such that an audience can view the content displayed on the screens 310. Each display screen 310 may have access to a media player 320 that is either embedded in or attached to the display screen 310. The media player 320 may be configured to retrieve the content and present it on the display screen 310 for the audience to view. The media player 320 may use network connectivity to retrieve the content from a content management system (CMS) 370. The media player 320 may provide formatting and presentation because the content stream is in industry-standard HTML/CSS/JavaScript.

The display screens 310 may have one or more audience measurement cameras 350 attached to them. The audience measurement camera 350 may be configured to monitor the number of people viewing content displayed on the display screen 310 and measures the time that they spend viewing. The audience measurement camera 350 may, for example, be configured to measure audience measurement data, such as emotional engagement and body language, The audience measurement data may be transmitted back to back-end analytic systems via network connectivity.

The media players 320, cameras 350 and, optionally, the display screens 310 (collectively, the “appliances”) may be connected to one or more network connectivity devices 360 that provide the ability for the appliances to connect to the back-end servers via the Internet. The network connectivity devices 360 may comprise wired and/or wireless connections between the device 360 and the appliances (eg, WiFi or Bluetooth) and between the network connectivity device and the Internet (eg, a cellular network).

The back-end servers may be hosted with a high-availability, redundant, cloud-based data centre. The back-end servers may operate a number of distinct systems and provide a number of services to manage and deliver the content to the display screens 310. CMS 370 may manage all aspects of the content and where different content is displayed. It may further provide tools for content curation, programming, allocation to screens and administration of advertising and the revenues generated from advertising. These revenues may be wholly or partially generated in cryptocurrencies, for example, Bitcoin. Where content is coursed from third-party feeds, the CMS 370 aggregates and manages that content also providing failover service to ensure uninterrupted operation for the audience.

A network management system (NMS) 380 may manage the network devices including active monitoring of the network and operation of the display screens 310. It may include rule-based automatic recovery of non-operational devices and a status dashboard to support operations. An analytics management system (AMS) 390 may manage audience engagement and correlate the engagement to the content. The AMS 390 may provide the measurement of advertiser value (or return on investment). A management console 400 may provide the ability for operators of the system to interact with the back-end servers. The servers may be cloud-based and hence the management console 400 may be accessed via an Internet-connected, industry-standard web browser. The management console may be multi-faceted to provide functionality to a range of users or operators as follows.
Content management that enables content curators to manage the content within the system including: how it is presented to the audience; the content presented at a particular location; configuration of third-party data sources and feeds; presentation of advertising and/or advertising sources; and all other aspects of content management.
Operations management that enables the operations team to manage every aspect of the commercial aspects of the system including: data feeds; revenue sharing; revenue reporting; advertising feeds and interfaces; and customer management.
Network management that enables monitoring and management of the network devices plus the ability to self-heal problems associated with the devices delivering the content to the audience.
Analytics reporting that provides the ability to report on advertising effectiveness, content effectiveness and content engagement levels. These reporting tools permit refinement of the content management and curation activities plus the ability to provide meaningful feedback to advertisers.

The content management system (CMS) 370 may provide the ability to manage the components within the overall system that are related to the delivery of content to the display screens 310. Elements of the CMS 370 are illustrated in FIG. 7. Hosts 410 may be organisations, companies or property owners that agree to permit the installation of display screens 310 so that they can be viewed by the host's visitor audience. Host organizations may have a commercial relationship that permits them to receive a commercial benefit that may be in the form of monetary payment. The nature of the benefit (or payment) is determined by the analytics capture but is managed against a host account within the CMS 370. For example, hosts 410 may comprise a hospital, a public transport provider, an airport, a coffee shop, etc.

Location areas 420 may be areas within the host's 410 properties that enable management of groups of locations 420. An example location area 420 for a railway network may be a specific railway station.

Locations 430 may be places within a location area 420 that define where display screens 310 are installed. An example for a railway station may be a specific railway platform. The location 430 may be used to identify location-specific content. An example of this is an advertisement for a shop at that platform.

Screen groups 440 may be known to the system 300 so that individual display screens 310 may be logically grouped together. Screen groups 440 may display the same content simultaneously. An example of this may be a screen group 440 on a specific railway platform where individual display screens 310 in the screen group 440 all display a location-specific widget that shows the next train to arrive at this platform.

Display screens 310 may be individually and selectively managed within the CMS 370 so that content can be assigned to them individually or collectively. This may be done through the allocation of a channel 450 to an individual digital screen 310, or to a screen group 440. Channels 450 may comprise streams of content that are assigned to a specific display screen 310.

To be relevant to a display screen 310, the channel 450 may include layouts 460 that define a combination of screen elements 470 that, together, define the set of content that the audience views on a display screen 310. Layouts 460 may be the mechanism that allows the implementation of the audience engagement model and the way that audiences are presented with multiple items of content that are entertaining, educational, informative and of a commercial nature. Layouts 460 may include a foundation background that has the ability to transition to a colour that is appropriate to the rest of the content.

Screen elements 470 may be the components of the display screen 310 that are presented together in a layout 460. The layouts 460 may comprise multiple, complimentary screen elements 470 that synergistically work together in a hierarchical manner to maximise audience interest and engagement. As described above, screen elements 470 may comprise digital content as follows.
Main stage 210 may comprise a large, feature image stream that is inspirational. The main stage image stream may be augmented with metadata annotations such as author/photographer/artist, curator, source, location/description, etc. It may also shows a count-down timer displaying the time that an aesthetic image will remain on the display screen 310.
Welcome/time/weather widget 260, 270, 240 may comprise widgets or feeds that are capable of displaying welcome message and/or current time and/or weather. Optionally, the weather and/or time can be specific to a location or destination, for example, in the case of a display screen 310 deployed in the departure lounge of an airport.
Question and answer (Q&A) trivia widget 250 may comprise a trivia feed that displays a question followed a few seconds later by the answer to that question. The Q&A may be presented in a text basis such that the text appears or scrolls into view on a timer with the question appearing first then the answer after a small delay. The presentation of Q&A in this manner may hold the audience's attention.
News feed 230 may comprise a set of news headlines that scroll into view.
Social trending feed may comprise a set of hash-tags or terms that are currently trending on social media.
Business news feed may comprise a set of financial data such as rates and prices relating to stocks, currencies and commodities markets presented in ticker format. This may include information such as stock last-sale prices, foreign currency exchange rates, commodity futures prices and index values.
Sponsor logos or branding 225 may comprise a set of one or more logos associated with permanent or semi-permanent sponsorship of the display screen 310. The sponsor logos may be associated with the host 410 or with a business that is local to the location area 420.
Advertising feed 220 may comprise a set of digital advertisements that are typically industry-standard sizes, presented on the display screen 310 to provide income to the provider of the display screen or the system 300.

Feeds 480 may comprise sources of digital content or data that are presented within a channel 450 as screen element 470 widgets. The feeds 480 may represent live or third-party data that does not originate within the CMS 370 or its media library 490. An example of a feed 480 is a weather feed 240 of the current weather at a location. The feeds 480 may, for example, further or alternatively comprise generic information feeds.

The media library 490 may comprise a set of content items or objects such as images, videos, questions and answers, logos, etc. Media library 490 items may be associated with a screen element 470 within a channel 450.

A content service 500 may comprise a set of media library 490 items associated with a screen element 470, within a layout 460, or within a channel 450. An example of this may comprise a set of main stage aesthetic, inspirational images (with annotations) within a layout 460 for a public transport system for a specific platform of a railway station in a railway line.

The AMS 390 may be integrated with the CMS 370 to deliver content to a particular display screen 310 that can be dynamically adapted to suit the audience as the analytics cameras 350 detect changes or patterns with the audience currently viewing. This adaptive content delivery may be controlled by rules programmed into the CMS 370 using AMS 390 dynamic analytic data.

The components that support the functionality of the system 300 may comprise the back-end servers and the media player 320. These two components may remain operational for the system 300 to be operational. Due to the complexity of the activities that they perform they are monitored for correct operation and corrective action performed if needed.

The NMS 380 may provide functionality to perform media player 320 polling by sending the media players 320 a small message and awaiting a response from the media player 320. If the media player 320 responds, then that information is stored in a database as being a successful poll. A history of media player 320 successful polls may be accessed via the management console 400. The most recent successful poll time may be displayed when the attributes of the media player 320 are viewed in the management console 400. If a media player 320 fails to respond to a poll then this is an alert situation and may result in automatic recovery or display of the alert on the management console's 400 dashboard.

The NMS 380 may be further configured to listen for media player 320 monitoring check-in advice. The media players 320 may be configured to check-in to the NMS 380 on a regular basis. The NMS 380 may receive the check-in messages and store the time of the check-in in the database. The most recent successful check-in time may be displayed when the attributes of the media player 320 are viewed in the management console 400. If a media player 320 fails to check-in within the expected interval, then this may be an alert situation and may result in automatic recovery or display of the alert on the management console's 400 dashboard.

The NMS 380 may comprise a dashboard that displays the health of the network and devices. It may display alerts where devices or components of the system 300 are not operating correctly. The alerts may provide click-thru capability to allow an operator to take corrective action on devices that are not operating correctly. The NMS 380 may further be configured to provide automatic recovery for devices that are not operating correctly. This capability may use rules and triggers to invoke automatic restart of devices that have failed to respond to polling and/or have failed to check-in within an acceptable interval.

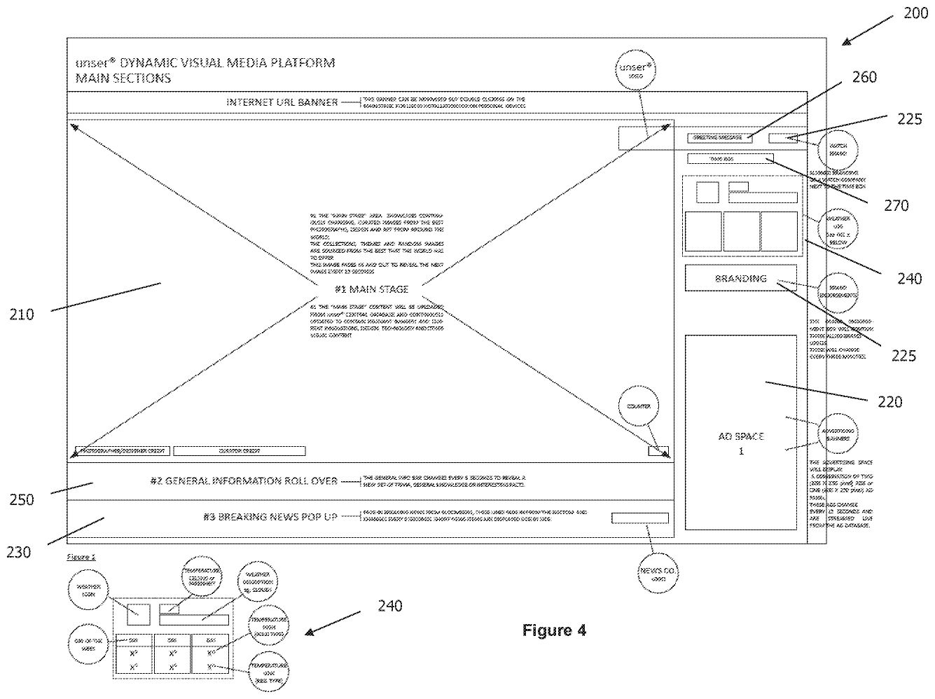

Each location 430 may use a layout template 460 that presents the screen elements in an aesthetically engaging manner. There may be multiple layout templates because they are specific to the screen elements 470 that are in use at each location 430. FIGS. 2 and 4 show example layout templates.

There may be multiple screen elements 470 per layout template that synergistically work together in a hierarchical manner to hold the attention of the audience beyond their individual potential. This multiple simultaneous hierarchical visual stimulation (MSHVS) may comprise multiple screen elements 470 that contribute to the user experience in different ways such as the main stage 210 providing inspirational content while the general information element provides educational content. Screen elements may comprise two or more of the following objects.
Main stage 210 may comprise a large aesthetic, inspirational, motivational or educational image from an image stream. The image may be augmented at bottom left with educational annotation including details such as the title, the artist or photographer, and the person that curated this main stage. The main stage may be presented for a predetermined duration and a small countdown timer may be shown at bottom right to inform the audience of impending transition to new main stage image.
The overall appearance may be aesthetically aligned to colour of the main stage via dynamic selection of a synergetic colour for the layout background.
Welcome message 260 may comprise a polite introduction to the layout, capturing the essence of being informative rather that obtrusive. The welcome message may automatically transition with time of day; ie, “good morning”, “good afternoon”, “good evening”. The welcome message may also be augmented with a sponsor logo 225, if applicable.
Current date and time 270 may comprise the current local date and time fully formatted to include day-of-week and seconds. In other locations, the date and time could be the date and time of a different location such as the destination of a flight when the display screen 310 is located in airport departure lounge.
Current weather 240 may comprise the local weather with a symbol plus current temperature accompanied by a three-day maximum and minimum forecast. Alternate formats may include enhanced details such as humidity, likelihood of rain and sunrise/sunset. The format of the weather may be aligned to the typical audience at the location where the display screen 310 is installed. The weather displayed may, instead of being local, be the weather of another location such as the destination of a flight when the display screen 310 is installed in the departure lounge of an airport.
Sponsor branding 225 may comprise a single logo or a set of logos of organisations that are associated with the provision of the display screen 310 in its location. If required, the sponsor logos may be a set that cycle through in an animated format. The sponsor logos may be designed to be clearly recognisable but unobtrusive. The other screen elements may be providing inspirational, aspirational and education content that delivers an engaging user experience. For these reasons sponsors may appreciate a benefit from being associated with the display screens 310.
General information 250 may comprise an educational screen element that is able to reveal the answer to a question a few seconds following display of the question. This mechanism for presentation of the answers may increase audience engagement and attention. The cycling between questions may be in a text basis such that the text appears or scrolls into view on a timer. Topic areas can be diverse covering areas such as animals, arts and architecture, gaming, geography, history, literature, medicine, music, nature, science, trivia and others. The set of questions and topics at a particular area is tailored to the location and the typical audience at that location. As an example, a location such as an airport could have focus on geography, whereas a location such as a hospital waiting room could have more emphasis on Medicine.
Breaking news may comprise a feed of news headlines 230. The source of the news feed may be credited.
Advertising 220 may comprise one or more digital advertisements using a combination of industry-standard display advertisement sizes. The advertising may provide the ability for the display screen 310 and content to generate income for the host, the operator, and the author of the content. The advertising may be presented in a supraliminal format but not so that it distracts the audience or detracts from the other content. The advertisements may cycle through a set, typically on a change interval that is less-frequent than the other screen elements.
Location or context-specific information feed may comprise details sourced from information feeds that are specific to the location. An example of this is the next train due at a railway platform, or the departure time of the next flight at an airport departure lounge.

The functionality of the system 300 may significantly enhance or improve the audience's user experience. This improvement may represent an altruistic aspect to stimulate neuroplasticity and deliver environmental enrichment to the audience. The medical benefits of neuroplasticity stimulation further enrich the user experience providing an additional layer of benefit to the audience hence adding additional value.

Each layout template may present content in the form of a channel 470 that has been curated and programmed for the specific location. In performing the curation and programming, the curator may take into consideration the location, the typical audience at the location, past analytics from that location, and the availability of location specific feeds. These factors may further differentiate the system 300 from legacy methods and provide enhanced user experience and value to the audience.

Elements and components of the method 100 and system 300 can be implemented in different languages or multiple languages. For example, the main stage 210, advertising 220, news feed 230, weather feed 240, general information or trivia feed 250, welcome message 260, date and time 270 may be implemented with multi-language capability.

The silent nature of the content delivered by the method 100 and system 300 may provide more versatility in screen location, and for there to be multiple concurrently operating display screens 310. Where multiple display screens 310 are deployed, the audience may have a choice of content and may be further enriched by the multiple sets of content available. Multiple display screens 310 may be harmonious to entice the audience, and may concurrently present multiple languages and formats to cater to culturally diverse audiences.

The analytics aspect of the system 300 may provide the ability to measure and capture audience engagement data, and then correlate it with content plus advertising. This may provide the ability to refine content to optimise the audience engagement plus provide accurate audience engagement figures to advertisers so that they can assess the effectiveness of the advertising. The analytics capture and processing functionality may comprise the following elements.
Cameras 350 may be positioned near or attached to the display screens 310 such that they are able to view and measure the level of audience engagement with the content. These cameras may use commercially available technology such as eye tracking software.
Data capture may integrate the captured audience engagement data with the CMS 370 within the back-end servers.
Content synchronization may comprise synchronising the audience engagement data with the content delivery and with the advertising. This three-way synchronisation may underpin the ability to refine and optimise the content and provide effectiveness measurements for advertising.

The analytics reporting functionality may be able to provide the following metrics.
Audience engagement may comprise an accurate report of the size of the audience mapped to time windows that can be matched to external events. Engagement may also be presented as peak and off-peak times of the day and/or week.
Conversion measurement may measure conversion of advertising to purchases by the audience.
Engagement measurement may map audience engagement to content so that a visualisation of how content can be refined and optimised for a particular location at a particular time. This engagement optimisation may provide an on-going capability to optimise the content as social trends and demographics change.
Effectiveness measurement may comprise assessment of the value obtained from the delivery of the content to the audience. This may enable the calculation of value or return on advertising investment to advertisers. This measurement may be able to be further enhanced via integration with beacon and interactive user engagement functionality.
Audience responses may be measured for the general benefit of social sciences, and to include illumination of pre-verbal mentality and sensitivities.

Embodiments of the present invention provide a method and system that are useful for displaying aesthetic images in conjunction with digital advertising. The aesthetic images may positively change or alter the minds of viewers in the sense that the plurality of aesthetic images may provide environmental enrichment to, and evoke neuroplasticity in, the viewers. As discussed above, conventional digital signage displays advertising to the audience on the basis that it will be noticed and the audience will respond. Although this approach can be effective, there is no implicit reason for the audience to be engaged by the advertising. It has long been the challenge for advertising executives to create engaging advertisements but even the most creative and engaging advertisements, once viewed once or twice, are no longer engaging. Conventional digital advertisers have even resorted to inclusion of attention-seeking sounds, often in situations where the introduction of sound is unnecessary and has an adverse impact to the situation. The result is digital signage content that seeks attention at the expense of a quality user experience for the audience. In contrast, embodiments of the present invention intrinsically engage through the presentation of inspirational, educational and informative content to the audience. The premise of embodiments of the invention is a vastly better user experience for the audience. When presented in a digital signage situation the audience is attracted to view the content for the aesthetic value it provides. This engaging content is then augmented, in a non-intrusive manner, with commercial advertising to provide a monetary return to the operator, the host of the digital signage screens and the author of the content. Embodiments of the invention deliver the engaging content in a silent fashion resulting in no collateral impact to the surrounding environment plus making the user experience complete even where there is ambient sound present.

Embodiments of the invention deliver location specific content to further enhance the user experience. The content is curated and tailored to unleash the established benefits from stimulating neuroplasticity and providing environmental enrichment to the audience. The silent nature of embodiments of the invention provides a non-invasive user experience whilst also providing the versatility to exist unobtrusively and in high ambient noise situations. The silent nature also provides the ability for multiple display screens to operate harmoniously for a culturally diverse audience using multiple languages.

The use of audience measurement technology integrated with the content delivery mechanism provides the ability to measure engagement and effectiveness and for the content to be optimised so that it remains relevant over time. In addition, the audience measurement integration provides the ability for the rule-based adaptive delivery of dynamic content based on the audience demographics and behaviour.

For the purpose of this specification, the word “comprising” means “including but not limited to,” and the word “comprises” has a corresponding meaning.

The above embodiments have been described by way of example only and modifications are possible within the scope of the claims that follow.

1-19. (canceled)

20. A method, comprising:
receiving an image stream at a display screen, wherein the image stream comprises a plurality of images each of which is aesthetically pleasing and of high aesthetic value or quality to viewers of the display screen;
displaying each image in the image stream in silence without accompanying sound;
displaying each image in the image stream on the display screen for a display period between 15 seconds and 30 seconds; and
wherein each image in the image stream is displayed on a major portion of the display screen.

21. The method of claim 20, further comprising displaying an advertising feed on the display screen adjacent to the image stream.

22. The method of claim 20, further comprising displaying a news feed on the display screen adjacent to the image stream.

23. The method of claim 20, further comprising displaying a business news feed on the display screen adjacent to the image stream.

24. The method of claim 20, further comprising a weather feed on the display screen adjacent to the image stream.

25. The method of claim 20, further comprising displaying a trivia feed on the display screen adjacent to the image stream.

26. The method of claim 20, further comprising displaying time and date on the display screen adjacent to the image stream.

27. The method of claim 20, further comprising displaying a welcome message on the display screen adjacent to the image stream.

28. The method of claim 20, wherein the display screen comprises a display screen of a digital device selected from a digital sign, a digital display, a personal computer, a laptop computer, a tablet computer, a smartphone, a smartwatch, a smart television, and combinations thereof.

29. The method of claim 20, further comprising capturing viewer responses while viewing the image stream on the display screen.

30. The method of claim 29, further comprising analysing the viewer responses.

31. A digital screen generated on a digital device by the method of claim 20.

32. A system, comprising:
a processor; and
a non-transitory computer-readable medium coupled to the processor and having instructions stored thereon, which, when executed by the processor, cause the processor to perform operations comprising:
receiving an image stream at a display screen, wherein the image stream comprises a plurality of images each having aesthetic value;
displaying each image in the image stream on the display screen in silence without accompanying sound;
displaying each image in the image stream on the display screen for a display period between 15 seconds and 30 seconds;
wherein each image in the image stream is aesthetically pleasing and of high aesthetic value or quality to viewers of the display screen; and
wherein each image in the image stream is displayed on a major portion of the display screen.

33. A non-transitory computer-readable medium having instructions stored thereon, which, when executed by a processor, cause the processor to perform operations comprising:
receiving an image stream at a display screen, wherein the image stream comprises a plurality of images each having aesthetic value;
displaying each image in the image stream on the display screen in silence without accompanying sound;
displaying each image on the display screen for a display period between 15 seconds and 30 seconds;
wherein each image in the image stream is aesthetically pleasing and of high aesthetic value or quality to viewers of the display screen; and
wherein each image in the image stream is displayed on a major portion of the display screen.

34. A system comprising a plurality of networked digital signs each configured to perform the method of claim 20.

35. A virtual art gallery comprising a plurality of networked display devices simultaneously displaying display screens generated by the method of claim 20.
